(19) United States
(12) Patent Application Publication
(10) Pub. No.: US 2026/0081886 A1
(43) Pub. Date: Mar. 19, 2026

(54) METHOD, APPARATUS, ELECTRONIC DEVICE AND STORAGE MEDIUM FOR INFORMATION PROCESSING

(71) Applicant: Beijing Zitiao Network Technology Co., Ltd., Beijing (CN)

(72) Inventors: Yan JIANG, Beijing (CN); Yonghui PAN, Beijing (CN); Xiaowen LV, Beijing (CN); Runqiong WANG, Beijing (CN); Hongye QI, Beijing (CN); Yuanhang XIE, Beijing (CN); Huimin WU, Beijing (CN); Eryou HAO, Beijing (CN); Ping YUAN, Beijing (CN); Yanping CHEN, Beijing (CN); Junzhou YANG, Beijing (CN); Sanwei TIAN, Beijing (CN); Zhenguha HAO, Beijing (CN); Qinggui XIE, Beijing (CN); Zhongjie FU, Beijing (CN); Weiquan WU, Beijing (CN); Zhiwu HU, Beijing (CN); Siyi WANG, Beijing (CN); Siyi WANG, Beijing (CN)

(21) Appl. No.: 19/110,044

(22) PCT Filed: Feb. 28, 2024
(86) PCT No.: PCT/CN2024/079152

§ 371 Date: Mar. 7, 2025

(30) Foreign Application Priority Data
Apr. 28, 2023 (CN) 202310485502.7

(51) Int. Cl. H04L 51/063; H04L 51/216

(52) U.S. Cl. CPC H04L 51/063; H04L 51/216

(57) ABSTRACT

The disclosure provides a method, apparatus, electronic device and storage medium for information processing. The method for information processing includes: obtaining a first link corresponding to at least one message in a first session; in response to an operation of sending the first link to a second business scenario, displaying first content in a second business scenario, wherein the first content comprises at least part of content of the at least one message; and updating the first content in the second business scenario accordingly based on change information of the at least one message.

This application claims the priority of China Patent Application No. 202310485502.7, filed on Apr. 28, 2023, entitled ‘METHOD, APPARATUS, ELECTRONIC DEVICE AND STORAGE MEDIUM FOR INFORMATION PROCESSING’, and the entire content of which is incorporated by reference.

### FIELD

The present disclosure relates to the technical field of computers, in particular to a method, apparatus, electronic device and storage medium for information processing.

### BACKGROUND

In the instant messaging scenario, a user needs to deliver the messages in the session to a further user. When the user changes the delivered message in the session, it is necessary to inform the further user additionally. This way of operation is cumbersome and easy to miss, resulting in poor user experience.

### SUMMARY

In view of this, the purpose of the present disclosure is to provide a method, apparatus, electronic device and storage medium for information processing.

Based on the above purpose, a first aspect of the present disclosure provides a method for information processing, including:
obtaining a first link corresponding to at least one message in a first session;
in response to an operation of sending the first link to a second business scenario, displaying first content in a second business scenario, wherein the first content includes at least part of content of the at least one message; and
updating the first content in the second business scenario accordingly based on change information of the at least one message.

In a second aspect of the present disclosure, a further method for information processing is provided, including:
obtaining a first link corresponding to at least one message in a first session;
in response to an operation of sending the first link to a second business scenario, displaying a first content in the second business scenario;
wherein a content presented in the first content includes the at least one message; and
wherein the content presented in the first content further includes:
an expression replied to the at least one message; and/or
in response to the at least one message including a topic message, a reply message to the topic message presented in the first content.

In a third aspect of the present disclosure, an apparatus for information processing is provided, including:
a first obtaining module configured to obtain a first link corresponding to at least one message in a first session;
a first display module configured to, in response to an operation of sending the first link to a second business scenario, display first content in a second business scenario, wherein the first content includes at least part of content of the at least one message; and
an updating module configured to update the first content in the second business scenario accordingly based on change information of the at least one message.

In a fourth aspect of the present disclosure, a further apparatus for information processing is provided, including:
a second obtaining module configured to obtain a first link corresponding to at least one message in a first session;
a second display module configured to, in response to an operation of sending the first link to a second business scenario, display a first content in the second business scenario;
wherein a content presented in the first content includes the at least one message; and
wherein the content presented in the first content further includes:
an expression replied to the at least one message; and/or
in response to the at least one message including a topic message, a reply message to the topic message presented in the first content.

In a fifth aspect of the present disclosure, a computer device is provided, a memory, a processor and a computer program stored in the memory and executable on the processor, the program, when executed by the processor, implementing the method for information processing of the first aspect or the second aspect.

In a sixth aspect of the present disclosure, a non-transitory computer-readable storage medium storing computer instructions is provided, the computer instructions, when executed by one or more processors, causing the processors to perform the method of the first aspect or the second aspect.

### BRIEF DESCRIPTION OF DRAWINGS

In order to explain the technical scheme in the present disclosure or related technology more clearly, the drawings needed to be used in the description of the embodiments or related technology would be briefly introduced below, obviously, the drawings in the following description are only the embodiments of the present disclosure, for ordinary people in the field, other drawings may be obtained according to these drawings without creative work.

FIG. 1 shows a schematic flow chart of an example method provided in an embodiment of the present disclosure.

FIG. 2A shows a schematic diagram of an example page according to an embodiment of the present disclosure.

FIG. 2B shows a schematic diagram of an example page according to an embodiment of the present disclosure.

FIG. 2C shows a schematic diagram of an example page according to an embodiment of the present disclosure.

FIG. 2D shows a schematic diagram of an example page according to an embodiment of the present disclosure.

FIG. 2E shows a schematic diagram of an example page according to an embodiment of the present disclosure.

FIG. 2F shows a schematic diagram of an example page according to an embodiment of the present disclosure.

FIG. 3 shows a schematic flow chart of an example method provided in an embodiment of the present disclosure.

FIG. 4 shows a schematic diagram of an example system provided by an embodiment of the present disclosure.

FIG. 5 shows a schematic diagram of an example apparatus provided by an embodiment of the present disclosure.

FIG. 6 shows a schematic diagram of an example apparatus provided by an embodiment of the present disclosure.

FIG. 7 shows a schematic diagram of a hardware structure of an example computer device provided by an embodiment of the present disclosure.

### DETAILED DESCRIPTION

In order to make the objectives, technical solutions and advantages of the present disclosure more clearly understood, the present disclosure is further described in detail below in combination with specific embodiments and with reference to the accompanying drawings.

It would be appreciated that, unless otherwise defined, technical terms or scientific terms used in the embodiments of the present disclosure would have their ordinary meanings as understood by people with ordinary skills in the field to which the present disclosure belongs. The words ‘first’, ‘second’ and similar words used in the embodiments of the present disclosure do not indicate any order, quantity or importance, but are only used to distinguish different components. Similar words such as ‘comprising’ or ‘including’ and the like mean that the elements or objects appearing before the word cover the elements or objects listed after the word and their equivalents, without excluding other elements or objects. The words ‘connected’ or ‘coupled’, and the like are not limited to physical or mechanical connections, but may include electrical connections, whether direct or indirect. ‘Up’, ‘down’, ‘left’, ‘right’, etc. are only used to indicate relative position relationships, when the absolute position of the described object changes, the relative position relationship may also change accordingly.

As mentioned in the background, in the multi-person session scenario of instant messaging, when a user needs to deliver a message in the session to other users, the user usually copies the content of the message directly in the session and then sends it to other users. Sometimes a user needs to edit the message in the session again, if the message has been delivered to other users, they need to deliver the edited message again, this operation is very troublesome, and users easily forget to deliver the edited message again, resulting in poor user experience.

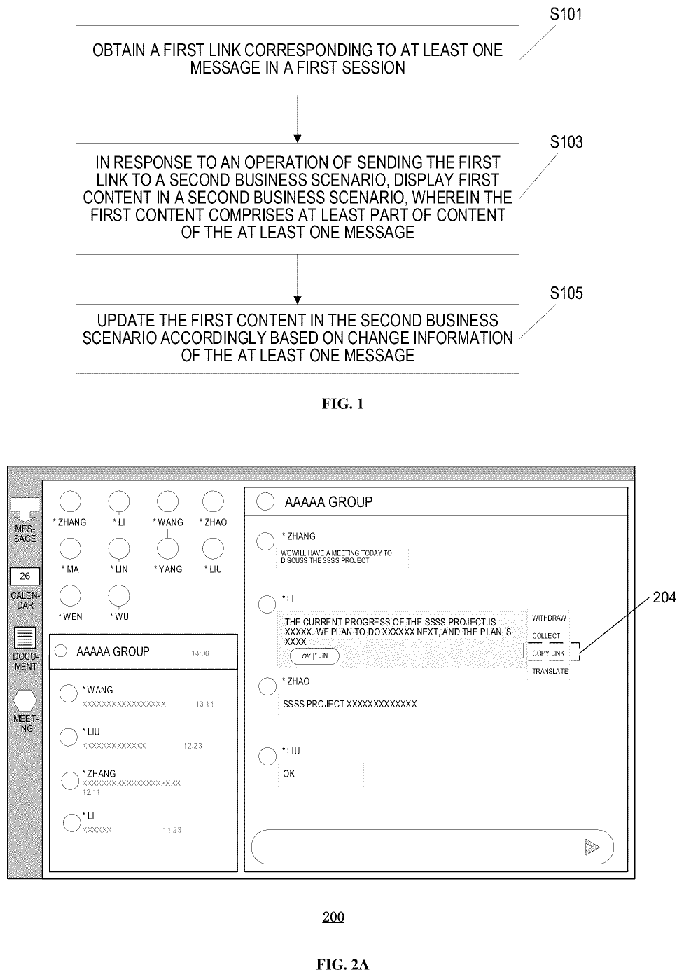

In view of this, the present disclosure provides a method for information processing to solve the above problems. As shown in FIG. 1, the method includes:

At Step S101: obtain a first link corresponding to at least one message in a first session.

In this embodiment, a user may obtain a first link corresponding to at least one message in a first session, wherein the first link is a link corresponding to at least one message, which may be a naked link. The first link may be configured to indicate a location of the at least one message in the first session, or indicate a storage location of the at least one message in the message server, that is, a source location of the at least one message may be located through the first link, this embodiment does not limit the form of the first link.

In some embodiments, the at least one message is a message displayed in the first session, and user A in the first session may directly obtain the first link corresponding to the at least one message by copying the message link in the first session.

Alternatively, the at least one message is a message displayed in the first session, after user B in the first session obtains the first link by copying the message link of the at least one message in the first session, the first link is sent to user A through a third session between user A and user B (user A may or may not be in the first session). Afterwards, user A directly copies and obtains the first link in the third session, this embodiment is not limited to this.

In some embodiments, obtaining a first link corresponding to at least one message in a first session in step S101, including:

At Step S201: in response to receiving a trigger on a message in the first session, displaying a first control, and in response to the trigger on the first control, obtaining a first link corresponding to the message.

Alternatively, at step S203: in response to receiving a multi-selection operation on at least two messages in the first session, displaying a second control, and in response to the trigger on the first control, obtaining the first link corresponding to the at least two messages.

In this embodiment, the first link may be obtained by copying the message link.

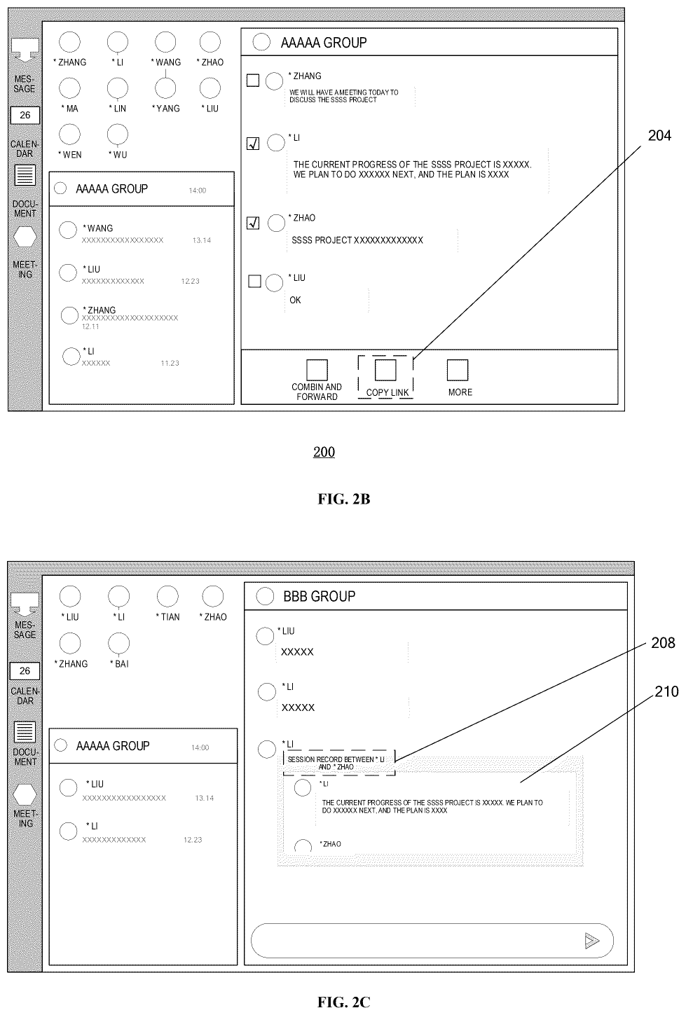

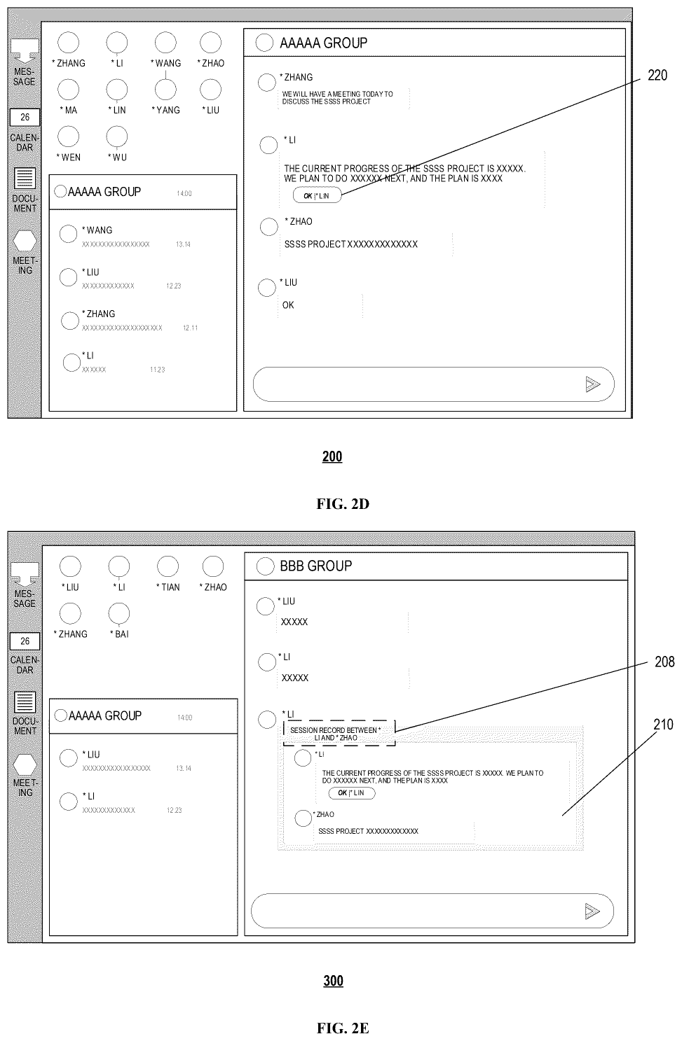

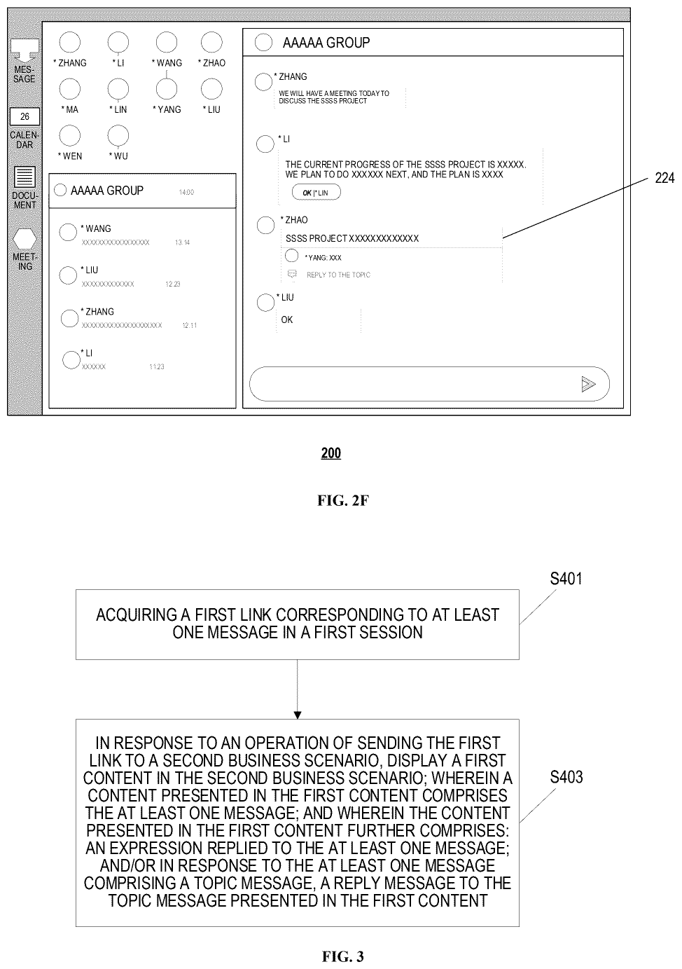

As shown in FIG. 2A, when the at least one message is a message in the first session, a first control 204 would be displayed in the first session when the message is triggered; when the first control 204 is clicked, the first link corresponding to the message may be directly obtained.

As shown in FIG. 2B, when the at least one message is at least two messages in the first session, the at least two messages may be selected by multi-selection operation, and a second control 204′ would also be displayed in the first session; when the second control 204′ is clicked, the first link corresponding to at least two messages may be directly obtained.

Step S103: in response to an operation of sending the first link to a second business scenario, displaying first content in a second business scenario, wherein the first content includes at least part of content of the at least one message.

In this embodiment, after obtaining the first link, the user may send the first link to the second business scenario. When the first link is sent to the second business scenario, the first content would be displayed in the second business scenario.

In some embodiments, the first content may include a first link and a message card, wherein at least part of the content in the at least one message would be displayed in the message card. When the user of the second business scenario triggers the message card, an expansion window of the message card may be displayed and all the content of the at least one message may be displayed in the expansion window, thus making the user of the second business scenario may browse all the at least one message. Certainly, in some embodiments, the message card may also display all the contents of the at least one message.

In some embodiments, when the member of the second business scenario is also in the first session, the first content displayed on the client of the member includes a text link and a message card; when the member of the second business scenario is not in the first session, the first content displayed on the client of the member includes a first link and a message card. In some embodiments, the text content in the text link represents the source information of the at least one message, and the first link is a naked link, which refers to the original character string display style of the link address.

Step S105: updating the first content in the second business scenario accordingly based on change information of the at least one message.

In this embodiment, when the user in the first session changes at least one message in the first session, the first content in the second business scenario is updated accordingly, so that the user in the second business scenario may also conveniently view the changed message without the user having to transmit the changed message again.

In this embodiment, a first link corresponding to at least one message in the first session is sent to the second business scenario, so that the first content including at least part of the content of the at least one message is displayed in the second business scenario; when at least one message is changed in the first session, the corresponding content in the second business scenario may be updated accordingly based on the change information, without the user having to transmit the changed message again, which is convenient for users to use and improves user experience.

In some embodiment, the second business scenario includes one or more of the following.

A second session being a further session other than the first session. As shown in FIG. 2C, when the second business scenario is the second session, the members of the second business scenario are the group members of the second session. When the member of the second business scenario is also in the first session, the first content displayed on the client of the member includes a text link 208 and a message card 210; when the member of the second business scenario is not in the first session, the first content displayed on the client of the member includes a first link and a message card, wherein the first link is a naked link.

A document, which may be a cloud document or a further various types of document. When the second business scenario is a document, the members of the second business scenario are the collaborators of the document, and the collaborators of the document include the owner, users with reading permission, users with editing permission, etc.; if the collaborators of the document are also in the first session, the first content displayed on the client of the user includes the text link 208 and the message card 210; if the collaborators of the document are not in the first session, the first content displayed on the client of the member includes the first link and the message card.

A schedule being a schedule service for managing a user's schedule. When the second business scenario is a schedule, the members of the second business scenario are the participants of the schedule, and the participants of the schedule include creating users, participating users, and the like.

An audio-video conference, when the second business scenario is an audio-video conference, the members of the second business scenario are the participating users of the audio-video conference.

A task, when the second business scenario is a task, the members of the second business scenario are the creating users and the participating users of the task.

An e-mail, when the second business scenario is the e-mail in the e-mailbox, the members of the second business scenario are the relevant personnel of the e-mail, including the sender, the recipient, the CC, etc.

A project management system, when the second business scenario is a project management system, the members of the second business scenario are the relevant participating users in the project management system, etc.

A customer relationship management system, when the second business scenario is a customer relationship management system, the members of the second business scenario are relevant participating users in the customer relationship management system, etc.

In the above embodiment, at least one message in the first session may be displayed in different types of second business scenarios in the form of first content by sending the first link, thereby satisfying user needs in different business scenarios and improving user experience.

In some embodiments, when the second business scenario is a second session, after the members of the first session obtain the first link corresponding to at least one message in the first session on their clients, they may send the first link to the client of the members in the second session through the instant messaging server (that is, the IM server). Tahe client of the member in the second session obtains at least one message corresponding to the first link from the instant messaging server based on the first link, and then renders the message content of the at least one message through the components on the client of the member in the second session, thereby obtaining the text link 208 and the message card 210.

In some embodiments, when the second business scenario is a document, after the members of the first session obtain the first link corresponding to at least one message in the first session on their clients, they may send the first link to the document server through the instant messaging server (that is, the IM server), and then the document server sends the first link and the related information of at least one message to the client of the collaborator of the document, so that the client of the collaborator of the document may render the related information of at least one message based on the components on the client, thereby obtaining the first content.

When the second business scenario is a schedule, audio-video conference, task, e-mailbox, project management system or customer relationship management system, correspondingly, the sending of the first link is implemented through an interaction between the schedule server, audio-video conference server, task server, e-mailbox server, project management system server, or customer relationship management system server and the IM server, the interaction mode is the same or similar to the interaction mode when the second business scenario is a document, and this embodiment would not repeat in details.

In some embodiments, the change information of the at least one message includes information indicating one or more of the following events.

In the first session, an expression reply is received for a message of the at least one message, which may be configured to express the information confirmation and attitude of the message. As shown in FIG. 2D, when an expression reply 220 is received for a certain message for at least one message in the first session ‘AAAAA group’, based on the method for information processing of this embodiment, the first content in the second business scenario may be updated based on the expression reply 220. As shown in FIG. 2E, when the second business scenario is a second session, the updated first content in the second session, that is, the message card, also displays the corresponding expression reply, thus making members in the second business scenario may know the confirmation and attitude conditions of other users to the corresponding message.

In the first session, a topic message reply is received for a message of the at least one message receives, and the topic message reply includes more message content in one message to ensure the integrity of the information. In this embodiment, when a topic message reply is received for a certain message for at least one message in the first session, the message card in the second business scenario also displays the corresponding topic message reply, thereby obtaining richer information and understand more contexts.

In the first session, an editing operation is performed on a message of the at least one message, and the editing operation is mostly a minor modification of the message content, for example, a typo. In this embodiment, when a certain message for at least one message in the first session is re-edited, the corresponding message after editing operation is also displayed in the message card in the second business scenario, thus making the message ideographic clearer and helping the user to prepare ideographic.

In the first session, a message of the at least one message is withdrawn. In this embodiment, when a certain message for at least one message in the first session is withdrawn by the user who sent the message, the withdrawn message would no longer be displayed in the message card in the second business scenario. Optionally, after the message is withdrawn in the first session, a prompt indicating that the message has been withdrawn would be displayed at a corresponding position of the withdrawn message, and the message card in the second business scenario would also display the prompt accordingly.

In the first session, a state of a message of the at least one message is changed. In this embodiment, when a certain message for at least one message in the first session has a status, the status may be, for example, in a satisfying, ended, etc., when the status of the message in the first session changes, for example, from in a satisfying to ended, the status of the message is changed accordingly in the message card in the second business scenario.

In some embodiments, updating the first content in the second business scenario accordingly based on change information of the at least one message in step S105 includes:

Step S301: for a member in the second business scenario, determining whether the member has a first permission for the at least one message in the first session.

Step S303: in response to the member having the first permission, updating the first content in the second business scenario on a client of the member accordingly.

Step S305: in response to the member failing to have the first permission, stop updating the first content in the second business scenario on the client of the member.

In this embodiment, when the first content in the second business scenario needs to be updated accordingly based on the change information in the first session, it is necessary to determine whether the members of the second business scenario have the first permission for the at least one message in the first session. In some embodiments, determining whether the member has the first permission for the at least one message in the first session includes one or more of the following.

In response to the member being a member of the first session, it is determined that the member has the first permission, and the first content in the second business scenario is updated accordingly on the client of the member; in response to the member not being a member of the first session, it is determined that the member fails to have the first permission, and stop updating the first content in the second business scenario on the client of the member.

In response to the member not being a member of the first session, but the first session is a public group with a public scope including the member, it is determined that the member has the first permission, and the first content in the second business scenario is updated accordingly on the client of the member; in response to the member not being a member of the first session and the first session is not a public group, or the member is not a member of the first session, the first session is a public group but the public scope does not include the member, it is determined that the member fails to have the first permission, and stop updating the first content in the second business scenario on the client of the member.

In response to if the at least one message in the first session being set to be visible to the member, it is determined that the member has the first permission, and the first content in the second business scenario is updated accordingly on the client of the member; in response to at least one message in the first session not set to be visible to the member, it is determined that the member fails to have the first permission, and stop updating the first content in the second business scenario on the client of the member.

In some embodiments, the second business scenario may include a plurality of members, and among these plurality of members, for some members who have the first permission, the first content in the second business scenario is updated accordingly on the client of the member; for some members who do not have the first permission, stop updating the first content in the second business scenario on the client of the member.

In some embodiments, after updating the first content in the second business scenario in step S105, it further includes: labeling a first message of the at least one message with a first predetermined identification in the second business scenario, or labeling a changed message of the at least one message with a second predetermined identification in the second business scenario.

In this embodiment, after updating the first content in the second business scenario, in order to make members in the second business scenario know that the first content has been updated, the first message of the at least one message may be labeled with a first predetermined identification in the second business scenario. For example, the first message is highlighted in a message card, so as to facilitate users to know that the message of the message card has been updated; or, in the second business scenario, the changed message of the at least one message is labeled with a second predetermined identification, for example, the changed message is highlighted in a message card, so as to facilitate users to know which message in the message card has been updated.

In some embodiments, the corresponding updating of the first content in the second business scenario in step S105, including: updating the first content in the second business scenario accordingly based on a trigger of a member in the second business scenario on the first content. In this embodiment, when the member in the second business scenario triggers the first content, it would trigger the update of the message card, at this time, the component of the client may be called to re-render the message card, thereby obtaining the updated message card.

In some embodiments, the trigger includes at least one of the following.

An open operation on the second business scenario. In this embodiment, when the member in the second business scenario opens a page of the second business scenario, such as opening a window of the second session, accessing a document, accessing a schedule, entering an audio-video conference, entering a task, opening an e-mail, entering a project management system or entering a customer relationship management system, an update of the message card may be triggered.

A refresh operation on the second business scenario. In this embodiment, when the member in the second business scenario refreshes a page of the second business scenario, for example, refreshing a document, an update of the message card may be triggered.

A click operation on the first link in the first content. In this embodiment, when the member in the second business scenario clicks on the first link, an update of the message card may be triggered.

A click operation on a text link in the first content, the text link corresponding to the first link. In this embodiment, when the member in the second business scenario clicks on the text link, an update of the message card may be triggered. Optionally, when the member in the second business scenario is in the first session, a text link would be displayed in the second business scenario; when the member in the second business scenario is not in the first session, the first link would be displayed in the second business scenario, and the first link is a naked link.

A click operation on a message card in the first content, at least part of content of the at least one message being presented in the message card. In this embodiment, when the member in the second business scenario clicks on a message card, an update of the message card may be triggered.

In some embodiments, the first link is associated with a message identification (message ID) of the at least one message. When a certain message for at least one message is changed, its change information is associated with the changed message. For example, when an expression reply is made to a certain message, there is an association between the expression reply and the message.

In some embodiments, when the second business scenario is a second session and a member in the second business scenario performs a trigger on the first content, the client of the member sends a request to an instant messaging server (IM server) based on the first link; the IM server obtains the message identification of at least one message based on the request, and then obtains the change information associated with at least one message based on the message identification; the client of the member pulls the change information associated with the at least one message from the IM server, and then the client updates the first content based on the change information, for example, rendering the message card based on a newly added expression reply, thereby obtaining an updated message card.

Alternatively, because the IM server stores the information that the first link is sent to the second session and the members in the second session, when a certain message for at least one message is changed, the IM server may obtain the change information associated with the at least one message, and determine the client of the member in the second session based on the first link, push the change information to the client of the member, and then the client updates the first content based on the change information, thereby obtaining the updated first content on the client of the member.

In some embodiments, when the second business scenario is a document and a member in the second business scenario performs a trigger on the first content, the client of the member sends a request to the document server based on the first link, and the document server sends a request to the IM server based on the request; the IM server obtains a message identification of at least one message based on the request, and then obtains change information associated with the at least one message based on the message identification, and sends the change information to the document server; the document server then sends the change information to the client of the member in the second business scenario, and then the client updates the first content based on the change information to obtain the updated first content on the client of the member.

Alternatively, since the IM server stores the first link and sends it to the document server, when a change is made to a certain message of the at least one messages, the IM server may obtain the change information associated with the at least one message, and determine the document server based on the first link, and push the change information to the document server. In this way, when the member in the second business scenario triggers the first content, the client of the member would send a request to the document server based on the first link, and the document server may send the change information to the client of the member in the second business scenario based on the request. Thereafter, the client updates the first content based on the change information, thereby obtaining the updated first content on the client of the member.

When the second business scenario is a schedule, audio-video conference, task, e-mailbox, project management system or customer relationship management system, correspondingly, the updating of change information is implemented through interaction between the schedule server, audio-video conference server, task server, e-mailbox server, project management system server, or customer relationship management system server and the IM server, the interaction mode is the same or similar to the interaction mode when the second business scenario is a document, and this embodiment would not repeat in details.

In some embodiments, the method further includes: setting a message type in the first session based on a first configuration operation of a first type user in the first session, to enable change information satisfying the message type to be used to update the first content in the second business scenario.

In some embodiments, the message type may include text messages, expression messages, picture messages, speech messages, video messages, cloud document messages, etc., or rich text messages that are a combination of the above types. The first type user may be the group owner, group administrator, etc. in the first session. In this embodiment, the first configuration operation may be configured to set which types of messages are allowed to update the first content in the second business scenario when the messages are changed. In this way, when change information appears in a certain message for at least one message, it is necessary to determine whether the message conforms to the message type set by the first configuration operation, and if so, the first content in the second business scenario is updated based on the change information.

In some embodiments, the method further includes: setting a message change type in the first session based on a second configuration operation of the first type user in the first session, to enable the change information satisfying the message change type to be used to update the first content in the second business scenario.

In some embodiments, the message change types may include: a message received an expression reply, a message received a topic message reply, a message being performed with an editing operation, a message withdrawn, a state of a message changed, a message translated, a message expedited, and a message labeled, etc. In this embodiment, based on the second configuration operation, it may be set which message change types'change information may update the first content in the second business scenario, for example, it may be set that the change information may update the first content in the second business scenario when the message receives an expression reply, the message receives a topic message reply, the message is edited, the message is withdrawn, or the message status changes, however, the change information would not update the first content in the second business scenario when the message is translated, the message is expedited, or the message is labeled, in this way, when change information appears in a certain message for at least one message, it is necessary to determine whether the message conforms to the message change type set by the second configuration operation, and if so, the first content in the second business scenario is updated based on the change information.

In some embodiments, the method further includes: based on a third configuration operation of the first type user in the first session, allowing change information of a user in the first session to be used to update the first content in the second business scenario.

In this embodiment, only when setting to allow the change information to update the first content in the second business scenario, when change information appears in a certain message for at least one message, the first content in the second business scenario would be updated based on the change information; if it is not set, it is not allowed to update the first content in the second business scenario based on the change information. In this embodiment, it may also be set by default to allow the change information to update the first content in the second business scenario, or it may be set by default not to allow the change information to update the first content in the second business scenario, and this embodiment does not limit this.

Based on the same inventive concept, corresponding to the method of any of the above embodiments, the present disclosure also provides a further method for information processing, as shown in FIG. 3, which includes:

Step S401: obtain a first link corresponding to at least one message in a first session.

Step S403: in response to an operation of sending the first link to a second business scenario, display a first content in the second business scenario.
wherein a content presented in the first content includes the at least one message; and wherein the content presented in the first content further includes: an expression replied to the at least one message; and/or in response to the at least one message including a topic message, a reply message to the topic message presented in the first content.

In this embodiment, after obtaining the first link, the user may send the first link to the second business scenario. When the first link is sent to the second business scenario, the first content would be displayed in the second business scenario.

In this specification, the first content displayed in the second business scenario includes at least one message, wherein at least one message in the first content may include a message content, user information of whom of sending the message, time of sending the message, sequence of a plurality of messages, message display format, etc., the message content may specifically include at least one of text, speech, image, video, document, expression, etc., and this embodiment does not limit this.

At the same time, the first content may also include an expression that makes an expression reply to a certain one or more messages in at least one message, as shown in FIG. 2D. Alternatively, as shown in FIG. 2F, when at least one message includes a topic message, a reply message 224 to the topic message is displayed in the first content.

In some embodiments, obtaining the first link corresponding to at least one message in the first session in step S401 includes:

Step S501: determine, based on a selection of the user, whether the first content of the first link includes an expression replied to the at least one message and/or a reply message to a topic message of the at least one message

Step S503: in response to the first content selected by the user including an expression replied to the at least one message and/or a reply message to the topic message of the at least one message, the first content displayed in the second business scenario includes: an expression replied to the at least one message, and/or a reply message to the topic message of the at least one message.

Step S505: in response to the first content selected by the user failing to include an expression replied to the at least one message and/or a reply message to the topic message of the at least one message, the first content displayed in the second business scenario fails to include: an expression replied to the at least one message, and/or a reply message to the topic message of the at least one message.

In this embodiment, when obtaining the first link corresponding to at least one message in the first session, if there is an expression reply to a certain message for at least one message in the first conversation, and the user also selects the expression when selecting at least one message in the first session, then at least one message in the first content displayed in the second business scenario also includes the expression; if there is an expression reply to a certain message for at least one message in the first conversation, but the user does not select the expression when selecting at least one message in the first session, then at least one message in the first content displayed in the second business scenario does not include the expression.

That is, in this embodiment, when the message in the first session includes an expression for an expression reply to the message, when the user copies the message link of the message in the first session to generate a first link and sends it to the second business scenario, if the user does not choose to copy the expression to generate the first link, the expression is not included in the first content displayed in the second business scenario; if the user chooses to copy the expression to generate the first link, the expression would be included in the first content displayed in the second business scenario, thereby satisfying the different messaging needs of the user.

If there is a topic message for at least one message in the first session and a reply message is generated by replying to the topic message, and the user also selects a reply message to the topic message when selecting at least one message in the first session, then at least one message in the first content displayed in the second business scenario also includes the reply message of the topic message; if there is a topic message for at least one message in the first session and a reply message is generated by replying to the topic message, but the user does not select the reply message of the topic message when selecting at least one message in the first session, then at least one message in the first content displayed in the second business scenario does not include the reply message of the topic message, but only includes the topic message.

That is, in this embodiment, when a topic message and a reply message to the topic message are included in the first session, when the user copies the message link of the topic message in the first session to generate a first link and sends it to the second business scenario, if the user does not choose to copy the reply message to generate the first link, the reply message is not included in the first content displayed in the second business scenario; if the user chooses to copy the reply message to generate the first link, the reply message is included in the first content displayed in the second business scenario, thereby satisfying the different message delivery needs of the user.

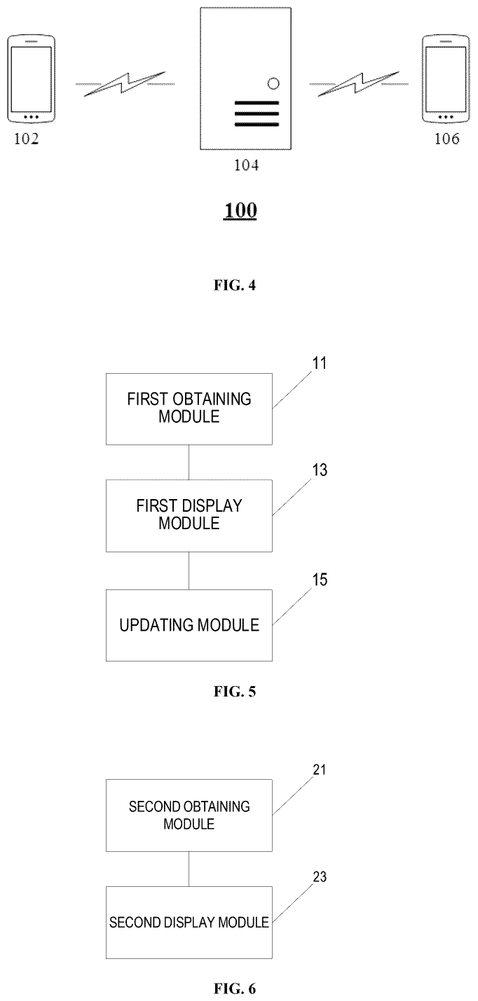

FIG. 4 shows a schematic diagram of an example system 100 provided by an embodiment of the present disclosure.

As shown in FIG. 4, the system 100 may include a first terminal 102, a server 104 and a second terminal 106. The first terminal 102 and the second terminal 106 are only configured to distinguish different electronic devices, and do not represent the number of electronic devices in an application scenario. In actual applications, there may be a plurality of electronic devices. The first electronic device 110 or the second electronic device 120 includes but is not limited to a desktop computer, a mobile phone, a mobile computer, a tablet computer, a media player, a smart wearable device, a personal digital assistant (PDA) or other electronic devices capable of realizing the above functions.

In some embodiments, the system 100 may be applied to a multi-person interaction scenario, e.g., instant session scenario, and the like. In this specification, the server 104 is configured to provide instant session service, wherein the first terminal 102/ the second terminal 106 is the terminal corresponding to the user who chats in the instant communication session scenario, and both of them are equipped with a client for communicating with the second terminal 106/ the first terminal 102, through which the user may enter a multi-person interactive scenario, for example, a multi-person chat scenario.

The server 104 may be a single server or a plurality of servers, in the scenario of the plurality of servers, these servers may adopt a distributed architecture and may form a server cluster.

The first terminal 102 and the second terminal 106 may be any terminal device, for example, they may be both mobile terminals (e.g., mobile phones, tablets) and fixed terminals (e.g., personal computers (PCs) and notebook computers). The first terminal 102 and the second terminal 106 may run application programs, and the application programs may provide users with corresponding services, for example, chat services.

FIG. 2A shows a schematic diagram of an example page 200 according to an embodiment of the present disclosure.

As shown in FIG. 2A, when the at least one message is a message in the first session, the first control 204 would be displayed in the first session when the message is triggered; when the first control 204 is clicked, the first link corresponding to the message may be directly obtained.

As shown in FIG. 2B, when a user wants to obtain a first link of at least two messages in a first session ‘AAAAA group’, the user may select the at least two messages through multi-selection operation and also display the second control 204′ in the first session; when the first user clicks the second control 204′, the first link corresponding to at least two messages may be directly obtained.

When the second business scenario is a second session, as shown in FIG. 2C, the user may send the first link to a second session ‘BBB group’, thereby displaying the first content in the second session ‘BBB group’, where the first content may include the text link 208 and the message card 210.

As shown in FIG. 2D, when change information appears in at least one message in the first session ‘AAAAA group’, for example, a certain message receives an expression reply 220, at this time, it is necessary to determine whether the user in the second session ‘BBB group’ has the first permission for the message in the first session ‘AAAAA group’, for example, whether the user is a member of the first conversation. If the user has permission, and when the user triggers a change on the client, the content of the message card 210 in the second session ‘BBB group’ is updated accordingly on the client of the user; if the user fails to have permission, the content of the message card 210 in the second session ‘BBB group’ is not updated accordingly on the client of the user.

It would be appreciated that the method of the embodiments of the present disclosure may be executed by a single device, e.g., a computer or a server, and the like. The method of this embodiment may also be applied to a distributed scenario, which is completed by the cooperation of a plurality of devices. In the case of such a distributed scenario, one of the plurality of devices may only execute a certain one or more steps in the method of the embodiments of the present disclosure, and the multiple devices may interact with each other to complete the described method.

It would be appreciated that some embodiments of the present disclosure have been described above. Other embodiments are within the scope of the appended claims. In some cases, the actions or steps recited in the claims may be performed in a different order than in the above embodiments and still implement the desired results. In addition, the processes depicted in the drawings do not necessarily require the specific order shown or the sequential order to achieve the desired results. In some embodiments, multitasking and parallel processing are also possible or may be advantageous.

Based on the same inventive concept, the present disclosure also provides an apparatus for information processing corresponding to the method of any of the above embodiments.

Referring to FIG. 5, the apparatus for information processing, including:
a first obtaining module 11 configured to obtain a first link corresponding to at least one message in a first session;
a first display module 13 configured to, in response to an operation of sending the first link to a second business scenario, display first content in a second business scenario, wherein the first content includes at least part of content of the at least one message; and
an updating module 15 configured to update the first content in the second business scenario accordingly based on change information of the at least one message.

In some embodiments, the change information of the at least one message includes information representing one or more of the following events:
in the first session, an expression reply is received for a message of the at least one message;
in the first session, a topic message reply is received for a message of the at least one message receives;
in the first session, an editing operation is performed on a message of the at least one message;
in the first session, a message of the at least one message is withdrawn; or
in the first session, a state of a message of the at least one message is changed.

In some embodiments, the updating module 15 is further configured to:
for a member in the second business scenario, determine whether the member has a first permission for the at least one message in the first session; and
in response to the member having the first permission, update the first content in the second business scenario on a client of the member accordingly; or
in response to the member failing to have the first permission, stop update the first content in the second business scenario on the client of the member.

In some embodiments, determining whether the member has the first permission for the at least one message in the first session includes one or more of the following:
in response to the member being a member of the first session, determining that the member has the first permission;
in response to the member not being a member of the first session, but the first session is a public group with a public scope including the member, determining that the member has the first permission; or in response to if the at least one message in the first session being set to be visible to the member, determining that the member has the first permission.

In some embodiment, the second business scenario includes one or more of the following:
a second session being a further session other than the first session;
a document;
a schedule;
an audio-video conference;
a task;
an e-mail;
a project management system; or
a customer relationship management system.

In some embodiments, the apparatus is further configured to: label a first message of the at least one message with a first predetermined identification in the second business scenario, or labeling a changed message of the at least one message with a second predetermined identification in the second business scenario.

In some embodiments, the updating module 15 is further configured to: update the first content in the second business scenario accordingly based on a trigger of a member in the second business scenario on the first content,
wherein the trigger includes at least one of the following:
an open operation on the second business scenario;
a refresh operation on the second business scenario;
a click operation on the first link in the first content;
a click operation on a text link in the first content, the text link corresponding to the first link; or
a click operation on a message card in the first content, at least part of content of the at least one message being presented in the message card.

In some embodiments, the apparatus is further configured to include at least one of the following:
setting a message type in the first session based on a first configuration operation of a first type user in the first session, to enable change information satisfying the message type to be used to update the first content in the second business scenario;
setting a message change type in the first session based on a second configuration operation of the first type user in the first session, to enable the change information satisfying the message change type to be used to update the first content in the second business scenario; or
based on a third configuration operation of the first type user in the first session, allowing change information of a user in the first session to be used to update the first content in the second business scenario.

For the convenience of description, when describing the above apparatuses, the functions are divided into various modules and described separately. Certainly, when practicing the present disclosure, the functions of each module may be implemented in the same one or more pieces software and/or hardware.

The apparatus of the above embodiment is configured to implement the corresponding method in any of the above embodiments, and has the beneficial effects of the corresponding method embodiment, which would not repeat in detail.

Based on the same inventive concept, the present disclosure also provides a further apparatus for information processing corresponding to the method of any of the above embodiments.

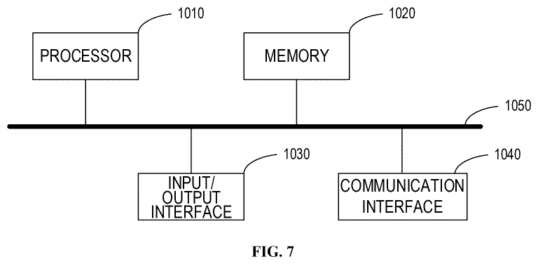

Referring to FIG. 6, the apparatus for information processing, includes:
a second obtaining module 21 configured to obtain a first link corresponding to at least one message in a first session;
a second display module configured to, in response to an operation of sending the first link to a second business scenario, display a first content in the second business scenario;
wherein a content presented in the first content includes the at least one message; and
wherein the content presented in the first content further includes:
an expression replied to the at least one message; and/or in response to the at least one message including a topic message, a reply message to the topic message presented in the first content.

In some embodiments, the second obtaining module 21 is further configured to:
obtaining the first link corresponding to at least one message in the first session include:
determining, based on a selection of the user, whether the first content of the first link includes an expression replied to the at least one message and/or a reply message to a topic message of the at least one message; and
wherein in response to the first content selected by the user including an expression replied to the at least one message and/or a reply message to the topic message of the at least one message, the first content displayed in the second business scenario includes: an expression replied to the at least one message, and/or a reply message to the topic message of the at least one message; or
wherein in response to the first content selected by the user failing to include an expression replied to the at least one message and/or a reply message to the topic message of the at least one message, the first content displayed in the second business scenario fails to include: an expression replied to the at least one message, and/or a reply message to the topic message of the at least one message.

For the convenience of description, when describing the above apparatuses, the functions are divided into various modules and described separately. Certainly, when practicing the present disclosure, the functions of each module may be implemented in the same one or more pieces software and/or hardware.

The apparatus of the above embodiment is used to implement the corresponding method in any of the above embodiments, and has the beneficial effects of the corresponding method embodiment, which would not repeat in detail.

Based on the same inventive concept, corresponding to the method of any of the above embodiments, the present disclosure also provides an electronic device, including a memory, a processor and a computer program stored in the memory and executable on the processor, the program, when executed by the processor, implementing the method for information processing of any of the above embodiments when executing the program.

FIG. 7 shows a more detailed schematic diagram of the hardware structure of electronic device provided by this embodiment, which may include a processor 1010, a memory 1020, an input/output interface 1030, a communication interface 1040 and a bus 1050. In this specification, the processor 1010, the memory 1020, the input/output interface 1030 and the communication interface 1040 implement the communication connection between each other within the device.

The processor 1010 may be implemented by a general-purpose CPU (Central Processing Unit), a microprocessor, an application-specific integrated circuit (ASIC), or one or more integrated circuits, and is used to execute relevant programs to implement the technical solutions provided in the embodiments of this specification.

The memory 1020 may be implemented in the form of ROM (Read Only Memory), RAM (Random Access Memory), static storage device, dynamic storage device, etc. The memory 1020 may store the operating system and other application programs, when the technical scheme provided by the embodiments of this specification are implemented by software or firmware, the relevant program codes are saved in the memory 1020 and invoked and executed by the processor 1010.

The input/output interface 1030 is used to connect input/output modules to implement information input and output. The input/output modules may be configured as components in device (not shown in figures) or may be externally connected to the device to provide corresponding functions. Input devices may include a keyboard, a mouse, a touch screen, a microphone, various sensors, etc., and output devices may include a display, a speaker, a vibrator, an indicator light, etc.

The communication interface 1040 is used to connect to a communication module (not shown in figures) to achieve communication interaction between the device and other devices. The communication module may achieve communication through wired means (e.g., USB, network cable, etc.) or wireless means (e.g., mobile network, WIFI, Bluetooth, etc.).

The bus 1050 includes a path to transmit information between various components of the device, for example, the processor 1010, the memory 1020, the input/output interface 1030 and the communication interface 1040.

It would be appreciated that, although the above device only shows the processor 1010, the memory 1020, the input/output interface 1030, the communication interface 1040 and the bus 1050, in the specific implementation process, the device may also include other components necessary for achieving normal operation. In addition, it would be appreciated by those skilled in the art that the above device may also include only the components necessary to implement the embodiments of this specification, and does not necessarily include all components shown in figures.

The electronic device of the above embodiment is used to implement the corresponding method in any of the above embodiments, and has the beneficial effects of the corresponding method embodiment, which would not repeat in detail.

Based on the same inventive concept, corresponding to the method of any of the above embodiments, the present disclosure also provides a non-transient computer-readable storage medium that stores computer instructions for causing the computer to execute the method of any of the above embodiments.

The computer-readable media of this embodiment include permanent and non-permanent, removable and non-removable media, and information storage may be implemented by any method or technology. Information may be computer-readable instructions, data structures, modules of programs or other data. Examples of storage media for computers include, but not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disk-read-only memory (CD-ROM), digital versatile disk (DVD) or other optical storage, magnetic cassettes, magnetic tape magnetic disk storage or other magnetic storage devices, or any other non-transmission medium that may be configured to store information that may be accessed by a computing device.

The computer instructions stored in the storage medium of the above embodiment are used to cause the computer to execute the method as described in any of the above embodiments, and have the beneficial effects of the corresponding method embodiment, which would not repeat in detail.

It would be appreciated by those skilled in the art that the discussion of any of the above embodiments is only example, and it is not intended to imply that the scope of the present disclosure (including the claims) is limited to these examples; under the idea of the present disclosure, the technical features in the above embodiments or different embodiments may also be combined, and the steps may be implemented in any order, and there are many other variations in different aspects of the embodiments of the present disclosure as described above, which are not provided in the details for the sake of brevity.

In addition, well known power/ground connections to integrated circuit (IC) chips and other parts may or may not be shown within the provided drawings, to simplify illustration and discussion, and so as not to obscure the disclosed embodiments. In addition, apparatuses may be shown in block diagram form in order to avoid making the embodiments of the present disclosure difficult to understand, and this also considers the fact that details about the implementation of these block diagram apparatuses are highly dependent on the platform where the embodiments of the present disclosure would be practiced (i.e., these details would be completely within the understanding range of those skilled in the art). In the case where specific details (e.g., circuits) are set forth to describe example embodiments of the present disclosure, it is obvious to those skilled in the art that the embodiments of the present disclosure may be practiced without these specific details or with changes in these specific details. Therefore, these descriptions would be regarded as illustrative rather than restrictive.

While the present disclosure has been described in conjunction with specific embodiments thereof, many alternatives, modifications and variations of these embodiments would be apparent to those skilled in the art in light of the foregoing description. For example, further memory architectures (e.g., dynamic RAM(DRAM)) may use the discussed embodiments.

The embodiments of the present disclosure are intended to cover all such alternatives, modifications and variations that fall within the broad scope of the appended claims. Therefore, any omission, modification, equivalent substitution, improvement, etc. made within the spirit and principles of the embodiments of the present disclosure would be included in the protection scope of the present disclosure.

1-14. (canceled)

15. A method for information processing, comprising:
obtaining a first link corresponding to at least one message in a first session;
in response to an operation of sending the first link to a second business scenario, displaying first content in a second business scenario, wherein the first content comprises at least part of content of the at least one message; and
updating the first content in the second business scenario accordingly based on change information of the at least one message.

16. The method according to claim 15, wherein the change information of the at least one message comprises information representing one or more of the following events:
in the first session, an expression reply is received for a message of the at least one message;
in the first session, a topic message reply is received for a message of the at least one message receives;
in the first session, an editing operation is performed on a message of the at least one message;
in the first session, a message of the at least one message is withdrawn; or
in the first session, a state of a message of the at least one message is changed.

17. The method according to claim 15, wherein updating the first content in the second business scenario accordingly based on change information of the at least one message comprises:
for a member in the second business scenario, determining whether the member has a first permission for the at least one message in the first session; and
in response to the member having the first permission, updating the first content in the second business scenario on a client of the member accordingly; or
in response to the member failing to have the first permission, stop updating the first content in the second business scenario on the client of the member.

18. The method according to claim 17, wherein determining whether the member has the first permission for the at least one message in the first session comprises one or more of the following:
in response to the member being a member of the first session, determining that the member has the first permission;
in response to the member not being a member of the first session, but the first session is a public group with a public scope comprising the member, determining that the member has the first permission; or
in response to if the at least one message in the first session being set to be visible to the member, determining that the member has the first permission.

19. The method according to claim 15, wherein the second business scenario comprises one or more of the following:
a second session being a further session other than the first session;
a document;
a schedule;
an audio-video conference;
a task;
an e-mail;
a project management system; or
a customer relationship management system.

20. The method according to claim 15, wherein after updating the first content in the second business scenario, the method further comprises:
labeling a first message of the at least one message with a first predetermined identification in the second business scenario, or labeling a changed message of the at least one message with a second predetermined identification in the second business scenario.

21. The method according to claim 15, wherein updating the first content in the second business scenario accordingly comprising:
updating the first content in the second business scenario accordingly based on a trigger of a member in the second business scenario on the first content,
wherein the trigger comprises at least one of the following:
an open operation on the second business scenario;
a refresh operation on the second business scenario;
a click operation on the first link in the first content;
a click operation on a text link in the first content, the text link corresponding to the first link; or
a click operation on a message card in the first content, at least part of content of the at least one message being presented in the message card.

22. The method according to claim 15, wherein the method further comprises at least one of the following:
setting a message type in the first session based on a first configuration operation of a first type user in the first session, to enable change information satisfying the message type to be used to update the first content in the second business scenario;
setting a message change type in the first session based on a second configuration operation of the first type user in the first session, to enable the change information satisfying the message change type to be used to update the first content in the second business scenario; or
based on a third configuration operation of the first type user in the first session, allowing change information of a user in the first session to be used to update the first content in the second business scenario.

23. A method for information processing, comprising:
obtaining a first link corresponding to at least one message in a first session;
in response to an operation of sending the first link to a second business scenario, displaying a first content in the second business scenario;
wherein a content presented in the first content comprises the at least one message; and
wherein the content presented in the first content further comprises:
an expression replied to the at least one message; and/or
in response to the at least one message comprising a topic message, a reply message to the topic message presented in the first content.

24. The method according to claim 23, wherein obtaining the first link corresponding to at least one message in the first session comprises:
determining, based on a selection of the user, whether the first content of the first link comprises an expression replied to the at least one message and/or a reply message to a topic message of the at least one message; and
wherein in response to the first content selected by the user comprising an expression replied to the at least one message and/or a reply message to the topic message of the at least one message, the first content displayed in the second business scenario comprises: an expression replied to the at least one message, and/or a reply message to the topic message of the at least one message; or
wherein in response to the first content selected by the user failing to comprise an expression replied to the at least one message and/or a reply message to the topic message of the at least one message, the first content displayed in the second business scenario fails to comprise: an expression replied to the at least one message, and/or a reply message to the topic message of the at least one message.

25. An electronic device comprising a memory, a processor and a computer program stored in the memory and executable on the processor, the program, when executed by the processor, performing acts comprising:
obtaining a first link corresponding to at least one message in a first session;
in response to an operation of sending the first link to a second business scenario, displaying first content in a second business scenario, wherein the first content comprises at least part of content of the at least one message; and
updating the first content in the second business scenario accordingly based on change information of the at least one message.

26. The electronic device according to claim 25, wherein the change information of the at least one message comprises information representing one or more of the following events:
in the first session, an expression reply is received for a message of the at least one message;
in the first session, a topic message reply is received for a message of the at least one message receives;
in the first session, an editing operation is performed on a message of the at least one message;
in the first session, a message of the at least one message is withdrawn; or
in the first session, a state of a message of the at least one message is changed.

27. The electronic device according to claim 25, wherein updating the first content in the second business scenario accordingly based on change information of the at least one message comprises:
for a member in the second business scenario, determining whether the member has a first permission for the at least one message in the first session; and
in response to the member having the first permission, updating the first content in the second business scenario on a client of the member accordingly; or
in response to the member failing to have the first permission, stop updating the first content in the second business scenario on the client of the member.

28. The electronic device according to claim 27, wherein determining whether the member has the first permission for the at least one message in the first session comprises one or more of the following:
in response to the member being a member of the first session, determining that the member has the first permission;
in response to the member not being a member of the first session, but the first session is a public group with a public scope comprising the member, determining that the member has the first permission; or
in response to if the at least one message in the first session being set to be visible to the member, determining that the member has the first permission.

29. The electronic device according to claim 25, wherein the second business scenario comprises one or more of the following:
a second session being a further session other than the first session;
a document;
a schedule;
an audio-video conference;
a task;
an e-mail;
a project management system; or
a customer relationship management system.

30. The electronic device according to claim 25, wherein after updating the first content in the second business scenario, the acts further comprise:
labeling a first message of the at least one message with a first predetermined identification in the second business scenario, or labeling a changed message of the at least one message with a second predetermined identification in the second business scenario.

31. The electronic device according to claim 25, wherein updating the first content in the second business scenario accordingly comprising:
updating the first content in the second business scenario accordingly based on a trigger of a member in the second business scenario on the first content,
wherein the trigger comprises at least one of the following:
an open operation on the second business scenario;
a refresh operation on the second business scenario;
a click operation on the first link in the first content;
a click operation on a text link in the first content, the text link corresponding to the first link; or
a click operation on a message card in the first content, at least part of content of the at least one message being presented in the message card.

32. The electronic device according to claim 25, wherein the acts further comprise at least one of the following:
setting a message type in the first session based on a first configuration operation of a first type user in the first session, to enable change information satisfying the message type to be used to update the first content in the second business scenario;
setting a message change type in the first session based on a second configuration operation of the first type user in the first session, to enable the change information satisfying the message change type to be used to update the first content in the second business scenario; or
based on a third configuration operation of the first type user in the first session, allowing change information of a user in the first session to be used to update the first content in the second business scenario.
